(19) United States
(12) Patent Application Publication
(10) Pub. No.: US 2021/0201118 A1
(43) Pub. Date: Jul. 1, 2021

(54) DEEP NEURAL NETWORKS (DNN) HARDWARE ACCELERATOR AND OPERATION METHOD THEREOF

(71) Applicant: INDUSTRIAL TECHNOLOGY RESEARCH INSTITUTE, Hsinchu (TW)

(72) Inventors: Yao-Hua CHEN, Fangyuan Township (TW); Wan-Shan HSIEH, Taoyuan City (TW); Juin-Ming LU, Hsinchu City (TW)

(73) Assignee: INDUSTRIAL TECHNOLOGY RESEARCH INSTITUTE, Hsinchu (TW)

(21) Appl. No.: 16/727,214

(22) Filed: Dec. 26, 2019

(51) Int. Cl. G06N 3/063; G06N 3/08; G06F 13/40; G06F 9/38

(52) U.S. Cl. CPC G06N 3/063; G06F 9/3877; G06F 13/4022; G06N 3/08

(57) ABSTRACT

A deep neural network (DNN) hardware accelerator including a processing element array is disclosed. The processing element array includes a processing element array, the processing element array including a plurality of processing element groups and each of the processing element groups including a plurality of processing elements. A first network connection implementation between a first processing element group of the processing element groups and a second processing element group of the processing element groups is different from a second network connection implementation between the processing elements in the first processing element group.

### TECHNICAL FIELD

The disclosure relates in general to a deep neural network (DNN) hardware accelerator and an operating method thereof.

### BACKGROUND

Deep neural network (DNN), which belongs to the artificial neural network (ANN), may be used in deep machine learning. The ANN has the learning function. The DNN has been widely used for resolving various problems, such as machine vision and speech recognition.

To enhance the efficiency of the DNN, a balance between transmission bandwidth and computing ability need to be reached in the design of the DNN. Therefore, it has become a prominent task for the industries to provide a scalable architecture for the DNN hardware accelerator.

### SUMMARY

According to one embodiment, a deep neural network (DNN) hardware accelerator including a processing element array is disclosed. The processing element array includes a plurality of processing element groups and each of the processing element groups includes a plurality of processing elements. A first network connection implementation between a first processing element group of the processing element groups and a second processing element group of the processing element groups is different from a second network connection implementation between the processing elements in the first processing element group

According to another embodiment, an operating method of a DNN hardware accelerator is provided. The DNN hardware accelerator includes a processing element array. The processing element array includes a plurality of processing element groups and each of the processing element groups includes a plurality of processing elements. The operating method includes: receiving input data by the processing element array; transmitting input data from a first processing element group of the processing element groups to a second processing element group of the processing element groups in a first network connection implementation; and transmitting data between the processing elements in the first processing element group in a second network connection implementation. The first network connection implementation is different from the second network connection implementation.

### BRIEF DESCRIPTION OF THE DRAWINGS

FIGS. 1A-1D are architecture diagrams of different networks.

FIG. 2A is a function block diagram of a DNN hardware accelerator according to an embodiment of the present disclosure.

FIG. 2B is a function block diagram of a DNN hardware accelerator according to an embodiment of the present disclosure.

FIG. 3 is a schematic diagram of a processing element group according to an embodiment of the present disclosure.

FIG. 4 is a schematic diagram of data transmission in a processing element array according to an embodiment of the present disclosure.

FIG. 5A is a function block diagram of a DNN hardware accelerator according to an embodiment of the present disclosure.

FIG. 5B is a function block diagram of a DNN hardware accelerator according to an embodiment of the present disclosure.

FIG. 6 is an architecture diagram of processing element groups according to an embodiment of the present disclosure, and a schematic diagram of connection between the processing element groups.

FIG. 7 is an architecture diagram of a processing element group according to an embodiment of the present disclosure.

FIG. 8 is a flowchart of an operating method of DNN hardware accelerator according to an embodiment of the present disclosure.

### DETAILED DESCRIPTION

Technical terms are used in the specification with reference to generally-known terminologies used in the technology field. For any terms described or defined in the specification, the descriptions and definitions in the specification shall prevail. Each embodiment of the present disclosure has one or more technical features. Given that each embodiment is implementable, a person ordinarily skilled in the art may selectively implement or combine some or all of the technical features of any embodiment of the present disclosure.

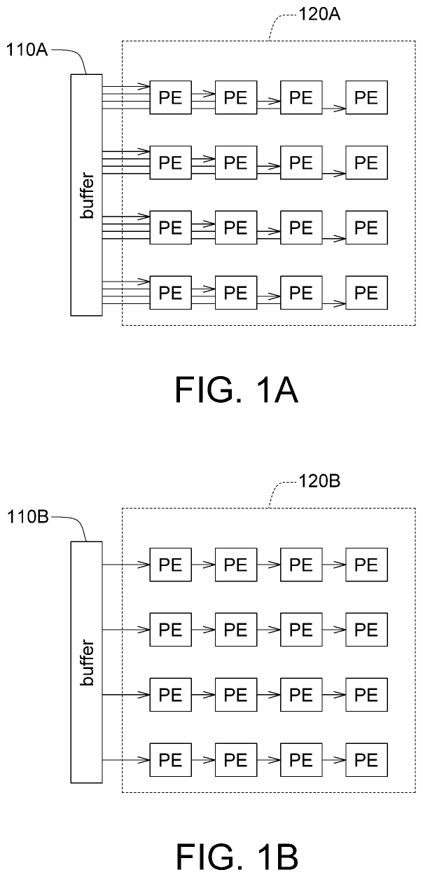

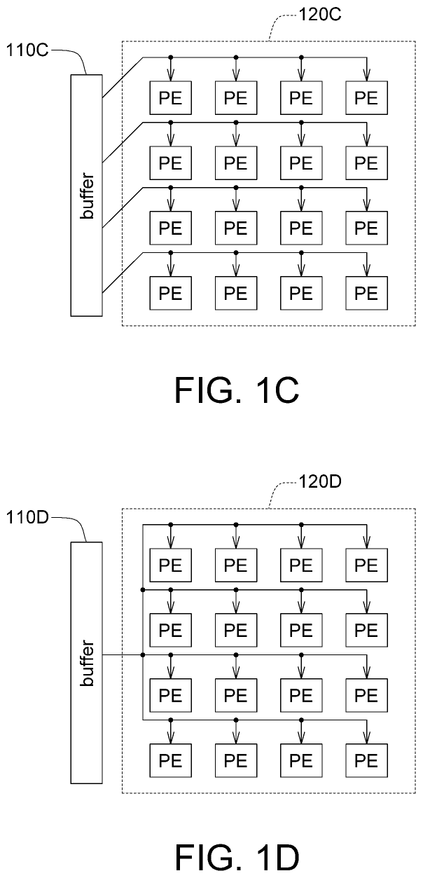

FIG. 1A is an architecture diagram of a unicast network. FIG. 1B is an architecture diagram of a systolic network. FIG. 1C is an architecture diagram of a multicast network. FIG. 1D is an architecture diagram of a broadcast network. FIGS. 1A-1D illustrate the relation between a buffer and a processing element (PE) array, but omit other elements for the convenience of explanation. For the convenience of explanation, in FIGS. 1A-1D, the processing element array includes 4×4 processing elements (4 rows each having 4 processing elements).

As indicated in FIG. 1A, in a unicast network, each PE has an exclusive data line. If data is to be transmitted from the buffer 110A to the 3rd PE counted from the left of a particular row of the processing element array 120A, then data may be transmitted to the 3rd PE of the particular row through the independent data line exclusive to the 3rd PE.

As indicated in FIG. 1B, in a systolic network, the buffer 110B and the 1st PE counted from the left of each row of the processing element array 120B share the same data line; the 1st PE and the 2nd PE counted from the left of each row share the same data line, and the rest may be obtained by the same analogy. That is, in a systolic network, the processing elements of each row share the same data line. If data is to be transmitted from the buffer 110B to the 3rd PE counted from the left of a particular row, then the data may be transmitted from the left of the particular row through the shared data line to the 3rd PE counted from the left of the particular row. To put it in greater details, in a systolic network, the output data (including the target identification code of the target processing element) of the buffer 110B is firstly transmitted to the first PE counted from the left of the row, and then is subsequently transmitted to other processing elements. The target processing element matching the target identification code will receive the output data, and other non-target processing elements of the target row will abandon the output data. In an embodiment, data may be transmitted in an oblique direction. For example, data is firstly transmitted from the 1st PE counted from the left of the third row to the 2nd PE counted from the left of the second row, and then is obliquely transmitted from the 2nd PE of the second row to the 3rd PE counted from the left of the first row.

As indicated in FIG. 1C, in a multicast network, the target processing element of the data is located by the respective addressing, and each processing element of the processing element array 120C respectively has an identification code (ID). After the target processing element of the data is determined, data is transmitted from the buffer 110C to the target processing element of the processing element array 120C. To put it in greater details, in a multicast network, output data (including the target identification code of the target processing element) of the buffer 110C is transmitted to all processing elements of the same target row. The target processing element of the target row matching the target identification code will receive the output data, and other non-target processing elements of the target row will abandon the output data.

As indicated in FIG. 1D, in a broadcast network, the target processing element of the data is located by the respective addressing, and each PE of the processing element array 120D respectively has an identification code (ID). After the target processing element of the data is determined, data is transmitted from the buffer 110D to the target processing element of the processing element array 120D. To put it in greater details, in a broadcast network, output data (including the target identification code of the target processing element) of the buffer 110D is transmitted to all processing elements of the processing element array 120D, the target processing element matching the target identification code will receive the output data, and other non-target processing elements of the processing element array 120D will abandon the output data.

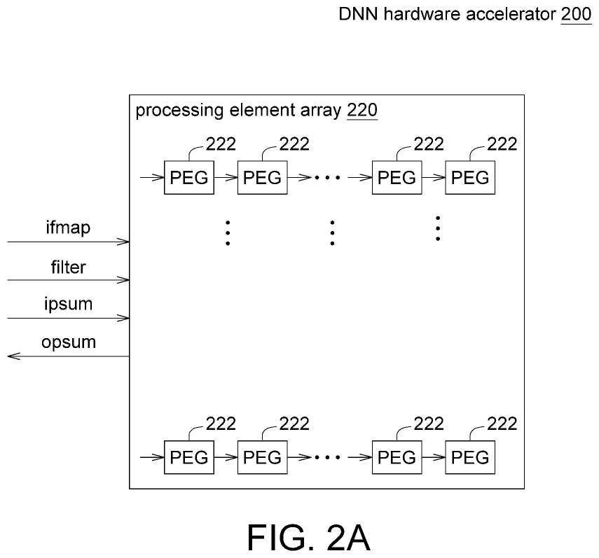

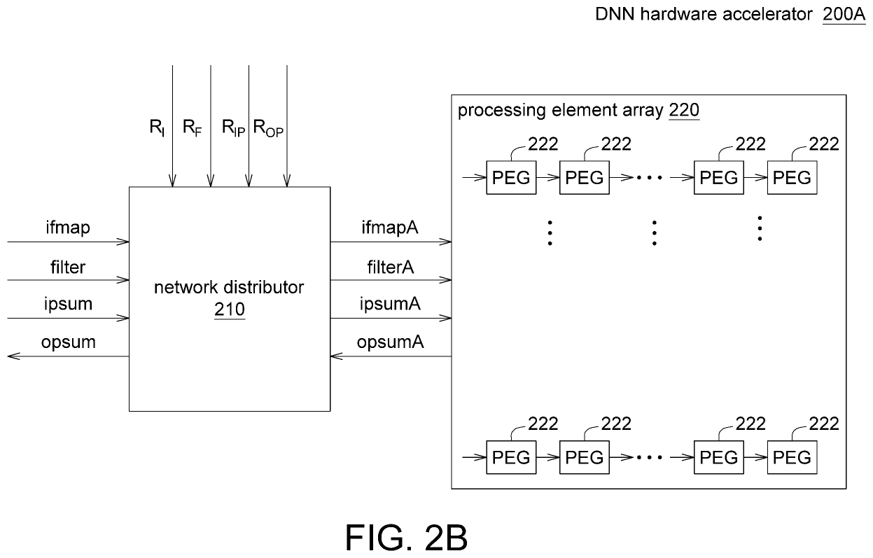

FIG. 2A is a function block diagram of a DNN hardware accelerator according to an embodiment of the present disclosure. As indicated in FIG. 2A, the DNN hardware accelerator 200 includes a processing element array 220. FIG. 2B is a function block diagram of a DNN hardware accelerator according to an embodiment of the present disclosure. As indicated in FIG. 2B, the DNN hardware accelerator 200A includes a network distributor 210 and a processing element array 220. The processing element array 220 includes a plurality of processing element groups (PEGs) 222. The network connection and data transmission between the processing element groups 222 may be performed using “systolic network” (as indicated in FIG. 1B). Each processing element group includes a plurality of processing elements. In the embodiments of the present disclosure, the network distributor 210 is an optional element.

In an embodiment of the present disclosure, the network distributor 210 may be realized by hardware, firmware or software or machine executable programming code stored in a memory and executed by a micro-processing element or a digital signal processing element. If the network distributor 210 is realized by hardware, then the network distributor 210 may be realized by single integrated circuit chip or multiple circuit chips, but the present disclosure is not limited thereto. The single integrated circuit chip or multiple circuit chips may be realized by a digital signal processing element, an application specific integrated circuit (ASIC) or a field programmable logic gate array (FPGA). The said memory may be realized by such as a random access memory, a read-only memory or a flash memory.

In an embodiment of the present disclosure, the processing element may be realized by a micro-controller, a micro-processing element, a processing element, a central processing unit (CPU), a digital signal processing element, an application specific integrated circuit (ASIC), a digital logic circuit, field programmable gate array (FPGA) and/or other hardware element with operation function. The processing elements may be coupled by an ASIC, a digital logic circuit, FPGA and/or other hardware elements.

The network distributor 210 allocates respective bandwidths of a plurality of data types according to the data bandwidth ratios (R_{I}, R_{F}, R_{IP}, and R_{OP}). In an embodiment, the DNN hardware accelerator 200 may adjust the bandwidth. Examples of the data types include input feature map (ifmap), filter, input partial sum (ipsum) and output partial sum (opsum). Examples of the data layer include convolutional layer, pool layer and/or fully-connect layer. For a particular data layer, it is possible that data ifmap may occupy a larger ratio; but for another data layer, it is possible that data filter may occupy a larger ratio. Therefore, in an embodiment of the present disclosure, respective bandwidth ratios (R_{I}, R_{F}, R_{IP} and/or R_{OP}) of the data layers may be determined according to the ratios of the data of respective data layers, and respective transmission bandwidths (such as the transmission bandwidth between the processing element array 220 and the network distributor 210) of the data types may be adjusted and/or allocated according to respective bandwidth ratios (R_{I}, R_{F}, R_{IP} and/or R_{OP}) of the data layers. The bandwidth ratios R_{I}, R_{F}, R_{IP} and R_{OP} respectively represent the bandwidth ratios of the data ifmap, filter, ipsum and opsum. The network distributor 210 may allocate the bandwidths of the data ifmapA, filterA, ipsumA and opsumA according to R_{I}, R_{F}, R_{IP} and R_{OP}, wherein, data ifmapA, filterA, ipsumA and opsumA represent the data transmitted between the network distributor 210 and the processing element array 220.

In an embodiment of the present disclosure, the DNN hardware accelerators 200 and 200A may selectively include a bandwidth parameter storage unit (not illustrated) coupled to the network distributor 210 for storing the bandwidth ratios R_{I}, R_{F}, R_{IP} and/or R_{OP} of the data layers and transmitting the bandwidth ratios R_{I}, R_{I}, R_{F}, R_{IP} and/or R_{OP} of the data layers to the network distributor 210. The bandwidth ratios R_{I}, R_{F}, R_{IP} and/or R_{OP} stored in the bandwidth parameter storage unit may be obtained through offline training.

In another possible embodiment of the present disclosure, the bandwidth ratios R_{I}, R_{F}, R_{IP} and/or R_{OP} of the data layers may be obtained in a real-time manner. For example, the bandwidth ratios R_{I}, R_{F}, R_{IP} and/or R_{OP} of the data layers are obtained from dynamic analysis of the data layers performed by a micro-processing element (not illustrated), and the bandwidth ratios are subsequently transmitted to the network distributor 210. In an embodiment, if the micro-processing element (not illustrated) dynamically generates the bandwidth ratios R_{I}, R_{F}, R_{IP} and/or R_{OP}, then the offline training for obtaining the bandwidth ratios R_{I}, R_{F}, R_{IP} and/or R_{OP} may be omitted.

In FIG. 2B, the processing element array 220 is coupled to the network distributor 210. The data types ifmapA, filterA, ipsumA and opsumA are transmitted between the processing element array 220 and the network distributor 210. In an embodiment, the network distributor 210 does not allocate respective bandwidths of a plurality of data types according to the bandwidth ratios (R_{I}, R_{F}, R_{IP}, R_{OP}) of the data. Instead, but transmits the data ifmapA, filterA and ipsumA to the processing element array 220 at a fixed bandwidth and receives data opsum from the processing element array 220. In an embodiment, the bandwidth/the number of bits of the bus of the data ifmapA, filterA, ipsumA and opsumA may be identical to that of the data ifmap, filter, ipsum and opsum; while in other possible embodiment, the bandwidth/the number of bits of the bus of the data ifmapA, filterA, ipsumA and opsumA may be different from that of the data ifmap, filter, ipsum and opsum.

In an embodiment of the present disclosure as indicated in FIG. 2A, the DNN hardware accelerator 200 may omit the network distributor 210. Under such architecture, the processing element array 220 receives or transmits data at a fixed bandwidth. For example, the processing element array 220 directly or indirectly receives data ifmap, filter and ipsum from a buffer (or memory) and directly or indirectly transmits data opsum to the buffer (or memory).

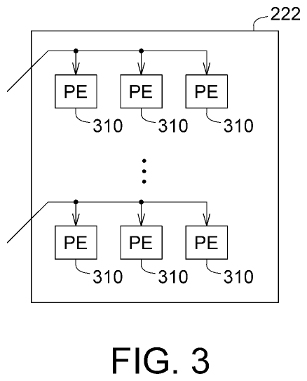

Referring to FIG. 3, a schematic diagram of a processing element group according to an embodiment of the present disclosure is shown. The processing element group of FIG. 3 may be used in FIG. 2A and/or FIG. 2B. As indicated in FIG. 3, the network connection and data transmission between the processing elements 310 in the same processing element group 222 may be performed using multicast network (as indicated in FIG. 1C).

In an embodiment of the present disclosure, the network distributor 210 includes a tag generation unit (not illustrated), a data distributor (not illustrated) and a plurality of first in first out (FIFO) buffers (not illustrated).

The tag generation unit of the network distributor 210 generates a plurality of row tags and a plurality of column tags, but the present disclosure is not limited thereto.

As disclosed above, the processing elements and/or the processing element groups determine whether to process an item of data according to the row tags and the column tags.

The data distributor of the network distributor 210 is configured to receive data (ifmap, filter, ipsum) and/or the output data (opsum) from the FIFO buffers and to allocate the transmission bandwidths of the data (ifmap, filter, ipsum, opsum) for enabling the data to be transmitted between the network distributor 210 and the processing element array 220 according to the allocated bandwidths.

The internal FIFO buffers of the network distributor 210 are respectively configured to buffer the data ifmap, filter, ipsum and opsum.

After data is processed, the network distributor 210 transmits the data ifmapA, filterA and ipsumA to the processing element array 220 and receives the data opsumA from the processing element array 220. Thus, the data may be more effectively transmitted between the network distributor 210 and the processing element array 220.

In an embodiment of the present disclosure, each processing element group 222 further selectively includes a row decoder (not illustrated) configured to decode the row tags generated by the tag generation unit (not illustrated) of the network distributor 210 to determine which row of processing elements will receive this item of data. Suppose the processing element group 222 includes 4 rows of processing elements. If the row tags are directed to the first row (such as, the value of the row tag is 1), then the row decoder, after decoding the row tags, transmits this item of data to the first row of processing elements, and the rest may be obtained by the same analogy.

In an embodiment of the present disclosure, the processing element 310 includes a tag matching unit, a data selection and allocation unit, an operation unit, a plurality of FIFO buffers and a reshaping unit.

The tag matching unit of the processing elements 310 compares the column tag, which is generated by the tag generation unit of the network distributor 210 or is received from the external of the processing element array 220, with the col. ID to determine whether the processing element needs to process this item of data. If the comparison shows that the two are matched, then the data selection and allocation unit processes this item of data (such as the ifmap, filter or ipsum of FIG. 2A, or the ifmapA, filterA or ipsumA of FIG. 2B).

The data selection and allocation unit of the processing elements 310 selects data from the internal FIFO buffers of the processing elements 310 to form the data ifmapB, filterB and ipsumB (not illustrated).

The operation unit of the processing elements 310 includes but is not limited to the multiplication and addition unit operation unit. In an embodiment of the present disclosure (as indicated in FIG. 2A), the data ifmapB, filterB and ipsumB formed by the data selection and allocation unit is processed into data opsum by the operation unit of the processing elements 310 and then is directly or indirectly transmitted to a buffer (or memory). In an embodiment of the present disclosure (as indicated in FIG. 2B), the data ifmapB, filterB and ipsumB formed by the data selection and allocation unit is processed into data opsumA by the operation unit of the processing elements 310 and is subsequently transmitted to the network distributor 210, which then uses the data opsumA as data opsum and transmits it out.

In an embodiment of the present disclosure, data inputted to the network distributor 210 may be from an internal buffer (not illustrated) of the DNN hardware accelerator 200A, wherein the internal buffer may be directly coupled to the network distributor 210. Or, in another possible embodiment of the present disclosure, the data inputted to the network distributor 210 may be from a memory (not illustrated) connected through a system bus (not illustrated). That is, the memory may possibly be coupled to the network distributor 210 through the system bus.

In a possible embodiment of the present disclosure, the network connection and data transmission between the processing element groups 222 may be performed using unicast network (as indicated in FIG. 1A), systolic network (as indicated in FIG. 1B), multicast network (as indicated in FIG. 1C) or broadcast network (as indicated in FIG. 1D), and such design is within the spirit of the present disclosure.

In a possible embodiment of the present disclosure, the network connection and data transmission between the processing elements in the same processing element group may be performed using unicast network (as indicated in FIG. 1A), systolic network (as indicated in FIG. 1B), multicast network (as indicated in FIG. 1C) or broadcast network (as indicated in FIG. 1D), and such design is within the spirit of the present disclosure.

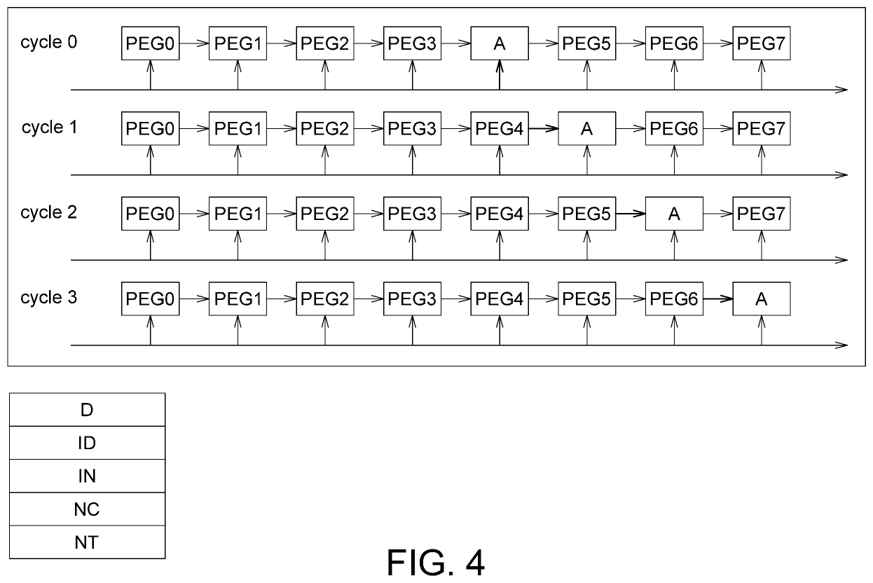

FIG. 4 is a schematic diagram of data transmission in a processing element array according to an embodiment of the present disclosure. As indicated in FIG. 4, there are two kinds of connection implementations between the processing element groups (PEG), i.e. unicast network and systolic network, and the connection implementation between the PEGs is switchable according to actual needs. For the convenience of explanation, data transmission between a particular row of processing element groups is exemplified below.

As indicated in FIG. 4, the data package may include a data field D, an identification code field ID, an increment field IN, a network change field NC, and a network type field NT. The data field, including data to be transmitted, has but is not limited to 64 bits. The identification code field ID, which has but is not limited to 6 bits, indicates which target processing element of the processing element group will receive the transmitted data, wherein each processing element group includes 64 processing elements for example. The increment field IN, which has but is not limited to 6 bits, indicates which processing element group will receive the data next by an incremental number, wherein each processing element group includes 64 processing elements for example. The network change field NC, having 1 bit, indicates whether the network connection implementation between the processing element groups needs to be changed or not: if the value of NC is 0, the network connection implementation does not need to be changed; if the value of NC is 1, the network connection implementation needs to be changed. The network type field NT, having 1 bit, indicates the type of network connection between the processing element groups: if the value of NT is 0, this indicates that the network type is unicast network; if the value of NT is 1, this indicates that the network type is systolic network.

Suppose data A is transmitted to the processing element groups PEG 4, PEG5, PEG6 and PEG7. The relation between data package and clock cycle is listed below:

| Clock cycle | 0 | 1 | 2 | 3 |
|---|---|---|---|---|
| D | A | A | A | A |
| ID | 4 | 4 | 4 | 4 |
| IN | 1 | 1 | 1 | 1 |
| NC | 1 | 0 | 0 | 0 |
| NT | 0 | 1 | 1 | 1 |

In the 0-th clock cycle, data A is transmitted to the processing element group PEG 4 (ID=4), and the network type is unicast network (NT=0). It is determined that the network type needs to be changed (NC=1, to change the network type from unicast network to systolic network) based on needs, and data A will subsequently be transmitted to the processing element group PEG 5 (IN=1). In the 1st clock cycle, data A is transmitted from the processing element group PEG 4 to the processing element group PEG 5 (ID=4+1=5), and the network type is systolic network (NT=1). It is determined that the network type does not need to be changed (NC=0), and data A will subsequently be transmitted to the processing element group PEG6 (IN=1). In the 2nd clock cycle, data A is transmitted from the processing element group PEG 5 (ID=4+1+1=6) to the processing element group PEG 6, and the network type is systolic network (NT=1). It is determined that the network type does not need to be changed (NC=0), and data A will subsequently be transmitted to the processing element group PEG7 (IN=1). In the 3rd clock cycle, data A is transmitted from the processing element group PEG 6 (ID=4+1+1+1=7) to the processing element group PEG 7, and the network type is systolic network (NT=1). It is determined that the network type does not need to be changed (NC=0).

In another embodiment, the ID field may be changed, and the relation between package and clock cycle is listed below:

| Clock cycle | 0 | 1 | 2 | 3 |
|---|---|---|---|---|
| D | A | A | A | A |
| ID | 4 | 5 | 6 | 7 |
| IN | 1 | 1 | 1 | 1 |
| NC | 1 | 0 | 0 | 0 |
| NT | 0 | 1 | 1 | 1 |

In the 0-th clock cycle, data A is transmitted to the processing element group PEG 4 (ID=4). In the 1st clock cycle, data A is transmitted from the processing element group PEG 4 to the processing element group PEG 5 (ID=4+1=5), and will subsequently be transmitted to the processing element group PEG6 (IN=1). In the 2nd clock cycle, data A is transmitted from the processing element group PEG 5 to the processing element group PEG 6 (ID=5+1=6), and will subsequently be transmitted to the processing element group PEG7 (IN=1). In the 3rd clock cycle, data A is transmitted from the processing element group PEG 6 to the processing element group PEG 7 (ID=6+1=7). The number, size and type of field may be designed according to actual needs, and the present invention does not have specific restrictions.

Thus, in the embodiments of the present disclosure, the network connection implementation between the processing element groups is switchable according to actual needs. For example, the network connection implementation may be switched between unicast network (as indicated in FIG. 1A), systolic network (as indicated in FIG. 1B), multicast network (as indicated in FIG. 1C) and broadcast network (as indicated in FIG. 1D) according to actual needs.

Similarly, in the embodiments of the present disclosure, the network connection implementation between the processing elements in the same processing element group is switchable according to actual needs. For example, the network connection implementation may be switched between unicast network (as indicated in FIG. 1A), systolic network (as indicated in FIG. 1B), multicast network (as indicated in FIG. 1C) and broadcast network (as indicated in FIG. 1D) according to actual needs. The principles are as disclosed above and are not repeated here.

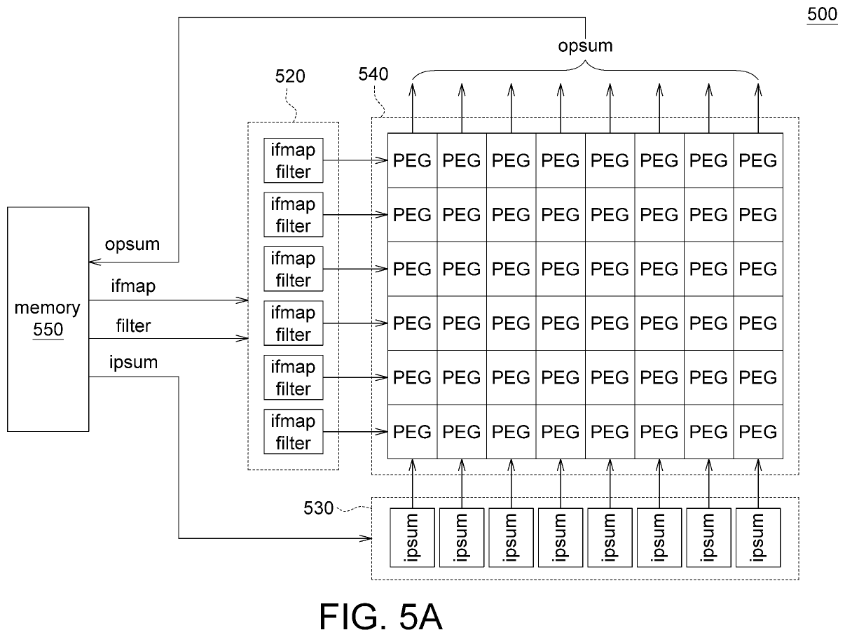

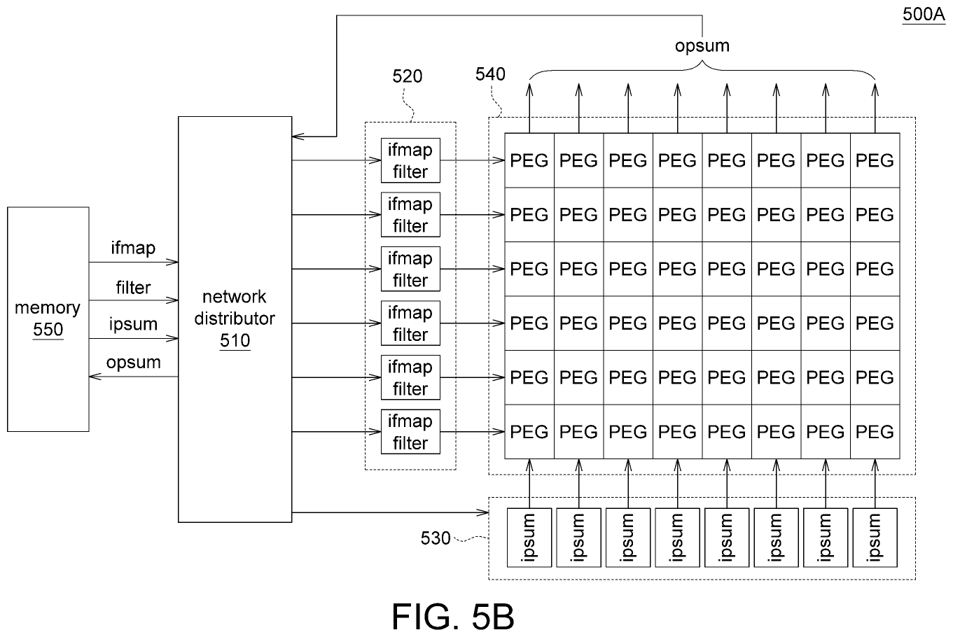

FIG. 5A is a function block diagram of a DNN hardware accelerator according to an embodiment of the present disclosure. As indicated in FIG. 5A, the DNN hardware accelerator 500 includes buffer 520, buffer 530, and a processing element array 540. As indicated in FIG. 5B, the DNN hardware accelerator 500A includes a network distributor 510, buffer 520, buffer 530, and a processing element array 540. The memory (DRAM) 550 may be disposed inside or outside of the DNN hardware accelerators 500 and 500A.

FIG. 5B is a function block diagram of a DNN hardware accelerator according to an embodiment of the present disclosure. In FIG. 5B, the network distributor 510 is coupled to the buffer 520, the buffer 530, and the memory 550 for controlling the data transfer between the buffers 520, the buffer 530, and the memory 550 and for controlling the buffer 520 and the buffer 530.

In FIG. 5A, the buffer 520 is coupled to memory 550 and the processing element array 540 for buffering the data ifmap and filter and subsequently transmitting the buffered data ifmap and filter to the processing element array 540. In FIG. 5B, the buffer 520 is coupled to the network distributor 510 and the processing element array 540 for buffering the data ifmap and filter and subsequently transmitting the buffered data ifmap and filter to the processing element array 540.

In FIG. 5A, the buffer 530 is coupled to memory 550 and the processing element array 540 for buffering data ipsum and transmitting the buffered data ipsum to the processing element array 540. In FIG. 5B, the buffer 530 is coupled to the network distributor 510 and the processing element array 540 for buffering data ipsum and transmitting the buffered data ipsum to the processing element array 540.

The processing element array 540 includes a plurality of processing element groups PEG configured to receive data ifmap, filter and ipsum from the buffers 520 and 530, process the received data into data opsum, and then transmit the processed data opsum to the memory 550.

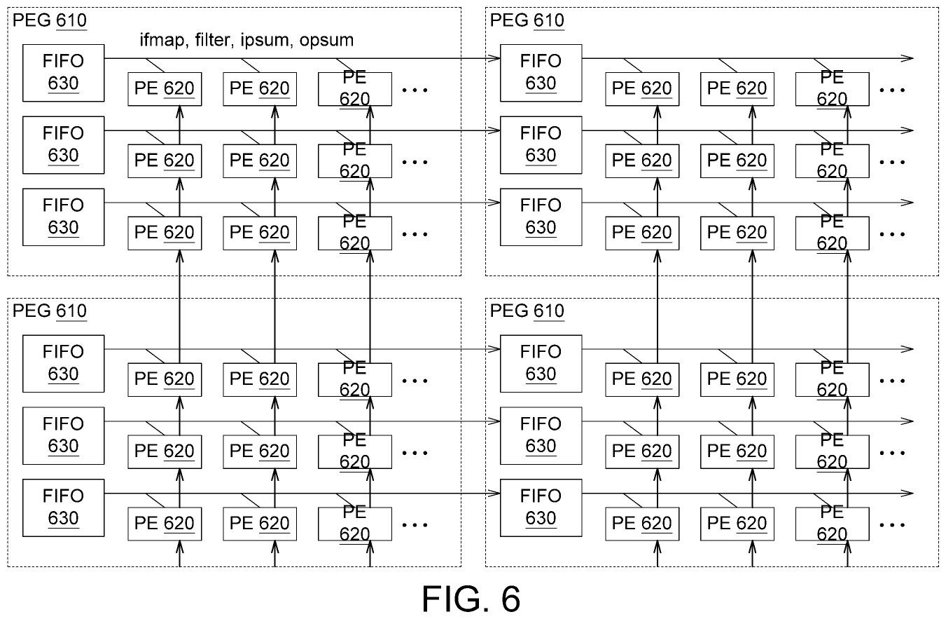

FIG. 6 is an architecture diagram of the processing element groups PEG according to an embodiment of the present disclosure, and a schematic diagram of the connection between the processing element groups PEG. As indicated in FIG. 6, the processing element groups 610 includes a plurality of processing elements 620 and a plurality of buffers 630.

In FIG. 6, coupling between the processing element groups 610 is implemented by systolic network. However, as disclosed in above embodiments, coupling between the processing element groups 610 may be implemented by other network connection, and the network connection implementation between the processing element groups 610 may be changed according to actual needs. Such design is still within the spirit of the present disclosure.

In FIG. 6, coupling between the processing elements 620 is implemented by multicast network. However, as disclosed in above embodiments, coupling between the processing elements 620 may be implemented by other network connection, and the network connection implementation between the processing elements 620 may be changed according to actual needs. Such design is still within the spirit of the present disclosure.

The buffers 630 are configured to buffer data ifmap, filter, ipsum and opsum.

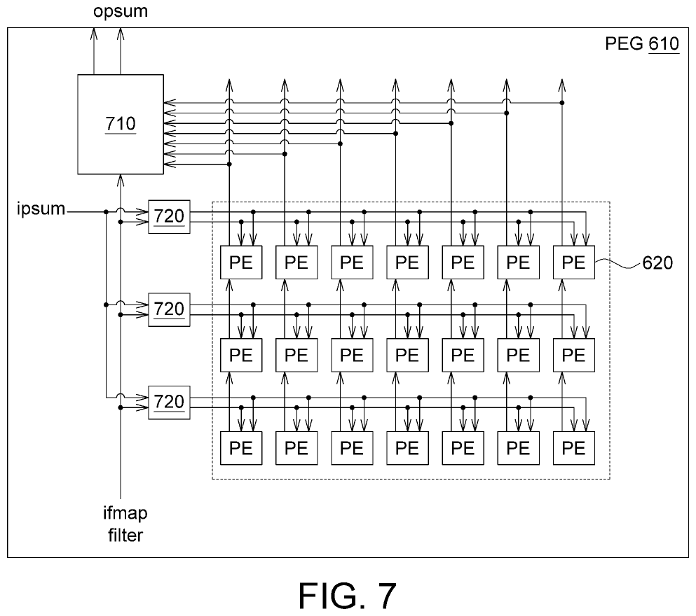

Referring to FIG. 7, an architecture diagram of a processing element group 610 according to an embodiment of the present disclosure is shown. As indicated in FIG. 7, the processing element group 610 includes a plurality of processing elements 620 and buffers 710 and 720. FIG. 7 is exemplified by a processing element group 610 including 3*7(=21) processing elements 620, but the present disclosure is not limited thereto.

In FIG. 7, coupling between the processing elements 620 is implemented by multicast network. However, as disclosed in above embodiments, coupling between the processing elements 620 may be implemented by other network connection, and the network connection implementation between the processing elements 620 may be changed according to actual needs. Such design is still within the spirit of the present disclosure.

The buffers 710 and 720 may be regarded as being equivalent to or similar to the buffers 630 of FIG. 6. The buffer 710 is configured to buffer data ifmap, filter and opsum. The buffer 720 is configured to buffer data ipsum.

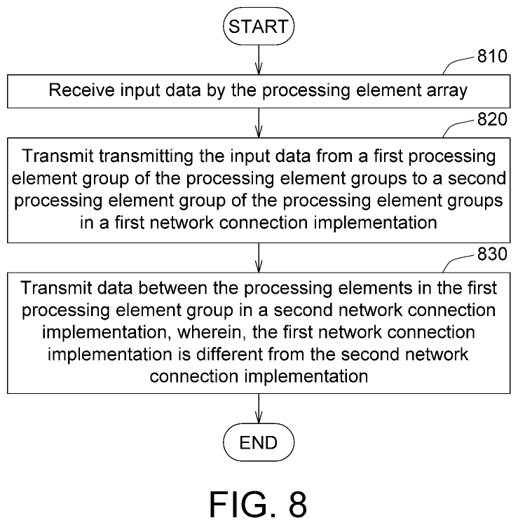

FIG. 8 is a flowchart of an operating method of DNN hardware accelerator according to an embodiment of the present disclosure. In step 810, input data is received by a processing element array, the processing element array including a plurality of processing element groups and each of the processing element groups including a plurality of processing elements. In step 820, input data is transmitted from a first processing element group of the processing element groups to a second processing element group of the processing element groups in a first network connection implementation. In step 830, data is transmitted between the processing elements in the first processing element group in a second network connection implementation, wherein, the first network connection implementation is different from the second network connection implementation.

In above embodiments of the present disclosure, coupling between the processing element groups are implemented in the same network connection implementation. However, in other possible embodiment of the present disclosure, the network connection implementation between the first processing element group and the third processing element group may be different from the network connection implementation between the first processing element group and the second processing element group.

In above embodiments of the present disclosure, for each processing element group, coupling between the processing elements are implemented in the same network connection implementation (for example, the processing elements in all processing element groups are coupled using “multicast network”). However, in other possible embodiment of the present disclosure, the network connection implementation between the processing elements in the first processing element group may be different from the network connection implementation between the processing elements in the second processing element group. In an illustrative rather than a restrictive sense, the processing elements in the first processing element group are coupled using “multicast network”, but the processing elements in the second processing element group are coupled using “broadcast network”.

In an embodiment, the DNN hardware accelerator receives input data. Between the processing element groups, data is transmitted by a first network connection implementation. Between the processing element groups in the same processing element group, data is transmitted by a second network connection implementation. In an embodiment, the first network connection implementation between the processing element groups is different from the second network connection implementation between the processing elements in each processing element group.

The present disclosure may be used in the artificial intelligence (AI) accelerator of a terminal device (such as a smart phone but not limited to) or the system chip of a smart coupled device. The present disclosure may also be used in an Internet of Things (IoT) mobile device, an edge computing server, a cloud computing server, and so on.

In above embodiments of the present disclosure, due to architecture flexibility (the network connection implementation between the processing element groups may be changed according to actual needs, and the network connection implementation between the processing elements also may be changed according to actual needs), the processing element array may be easily augmented.

As disclosed in above embodiments of the present disclosure, the network connection implementation between the processing element groups may be different from the network connection implementation between the processing elements in the same processing element group. Or, the network connection implementation between the processing element groups may be identical to the network connection implementation between the processing elements in the same processing element group.

As disclosed in above embodiments of the present disclosure, the network connection implementation between the processing element groups may be unicast network, systolic network, multicast network or broadcast network, and is switchable according to actual needs.

As disclosed in above embodiments of the present disclosure, the network connection implementation between the processing elements in the same processing element group may be unicast network, systolic network, multicast network or broadcast network, and is switchable according to actual needs.

The present disclosure provides a DNN hardware accelerator effectively accelerating data transmission. The DNN hardware accelerator advantageously possesses the features of adjusting the corresponding bandwidth according to the needs in data transmission, reducing network complexity, and providing a scalable architecture.

As described above, embodiments of the application are disclosed as above but the application is not limited. Those skilled in the technical field of the application would do various modifications and variations within the spirit and the scope of the application. Therefore, scope of the application is defined by the following claims.

What is claimed is:

1. A deep neural network (DNN) hardware accelerator, comprising:
a processing element array comprising a plurality of processing element groups and each of the processing element groups comprising a plurality of processing elements, wherein, a first network connection implementation between a first processing element group of the processing element groups and a second processing element group of the processing element groups is different from a second network connection implementation between the processing elements in the first processing element group.

2. The DNN hardware accelerator according to claim 1, wherein, the first network connection implementation comprises unicast network, systolic network, multicast network or broadcast network.

3. The DNN hardware accelerator according to claim 1, wherein, the first network connection implementation is switchable.

4. The DNN hardware accelerator according to claim 1, wherein, the second network connection implementation comprises unicast network, systolic network, multicast network or broadcast network.

5. The DNN hardware accelerator according to claim 1, wherein, the second network connection implementation is switchable.

6. The DNN hardware accelerator according to claim 1, further comprising a network distributor coupled to the processing element array for receiving input data, wherein, the network distributor allocates respective bandwidths of a plurality of data types of the input data according to a plurality of bandwidth ratios, and respective data of the data types is transmitted between the processing element array and the network distributor according to respective allocated bandwidths of the data types.

7. The DNN hardware accelerator according to claim 6, wherein, the bandwidth ratios are obtained from dynamic analysis of a micro-processing element and transmitted to the network distributor.

8. The DNN hardware accelerator according to claim 6, wherein, the network distributor receives the input data from a buffer or from a memory coupled through a system bus.

9. An operating method of a DNN hardware accelerator including a processing element array, the processing element array comprising a plurality of processing element groups and each of the processing element groups comprising a plurality of processing elements, the operating method comprising:
receiving input data by the processing element array;
transmitting the input data from a first processing element group of the processing element groups to a second processing element group of the processing element groups in a first network connection implementation; and
transmitting data between the processing elements in the first processing element group in a second network connection implementation,
wherein, the first network connection implementation is different from the second network connection implementation.

10. The operating method of DNN hardware accelerator according to claim 9, wherein, the first network connection implementation comprises unicast network, systolic network, multicast network or broadcast network.

11. The operating method of DNN hardware accelerator according to claim 9, wherein, the first network connection implementation is switchable.

12. The operating method of DNN hardware accelerator according to claim 9, wherein, the second network connection implementation comprises unicast network, systolic network, multicast network or broadcast network.

13. The operating method of DNN hardware accelerator according to claim 9, wherein, the second network connection implementation is switchable.

14. The operating method of DNN hardware accelerator according to claim 9, wherein, the DNN hardware accelerator further comprises a network distributor, the network distributor allocating respective bandwidths of a plurality of data types of the input data according to a plurality of bandwidth ratios, and respective data of the data types are transmitted between the processing element array and the network distributor according to respective allocated bandwidths of the data types.

15. The operating method of DNN hardware accelerator according to claim 14, wherein, the bandwidth ratios are obtained from dynamic analysis of a micro-processing element and transmitted to the network distributor.

16. The operating method of DNN hardware accelerator according to claim 14, wherein, the network distributor receives the input data from a buffer or from a memory coupled through a system bus.
